(19) United States
(12) Patent Application Publication
(10) Pub. No.: US 2015/0067204 A1
(43) Pub. Date: Mar. 5, 2015

(54) PRINTING SYSTEM AND CONTROL METHOD OF PRINTING SYSTEM

(71) Applicant: SEIKO EPSON CORPORATION, Tokyo (JP)

(72) Inventors: Naoki HORIE, Fukuoka (JP); Shoji HOSHINA, Shiojiri (JP); Katsuya TANAKA, Kitakyushu (JP); Shinichiro FUJITA, Kitakyushu (JP)

(21) Appl. No.: 14/470,317

(22) Filed: Aug. 27, 2014

(30) Foreign Application Priority Data
Aug. 30, 2013 (JP) 2013-179290

(51) Int. Cl. G06F 13/38; H04W 8/22

(52) U.S. Cl. CPC G06F 13/385; H04W 8/22
USPC 710/63

(57) ABSTRACT

For a printing system, a printing device and an information terminal are connected by communication. The printing device includes a wired communication unit configured to communicate by USB, a connection confirmation unit configured to confirm the connection to the information terminal, and a boot application determination unit configured to notify the information terminal of the application to be booted at the information terminal. The information terminal includes a wired communication unit configured to communicate by USB, a wireless communication unit configured to communicate with a server, an application existence determination unit configured to determine installation, a download site determination unit configured to determine a server, an install unit configured to acquire the application from the server and install, and an application boot unit configured to boot the application.

### CROSS-REFERENCE TO RELATED APPLICATIONS

This application claims priority to Japanese Patent Application No. 2013-179290 filed on Aug. 30, 2013. The entire disclosure of Japanese Patent Application No. 2013-179290 is hereby incorporated herein by reference.

### BACKGROUND

1. Technical Field

The present invention relates to a printing system and a control method of the printing system.

2. Related Art

Recently, as shown in Japanese Laid Open Patent Publication No. 2004-40703, a system in which high function mobile phones called smartphones and information terminals like multiple function mobile terminals called tablet PCs are connected to printing devices such as printers via wireless connections, and printing is performed on the basis of print data transmitted from the information terminals have been well known.

As a typical example of the wireless connection, Bluetooth (registered trademark) has been well known. Bluetooth uses radio wave in high frequency of 2.45 GHz as a transmission medium, communicates in 3 Mbps in the maximum transmission speed for a distance of a couple meters away, and can perform data communication efficiently among a plurality of terminals because there is no access point necessary and because the terminals are directly connect.

However, Bluetooth needs recognizing communication partners, which is called paring, before the data communication, and connection settings are bothersome for users who are not accustomed and thus use a lot of time and effort to do the data communication by Bluetooth.

### SUMMARY

The present invention is conceived in respect to the above mentioned problems, and has an objective to provide a system which allows an easy connection of a printing device and an information device and in which the information device makes the printing device print.

The present invention is conceived to solve at least part of the above mentioned problems, and arrangements, and applied examples can make it possible.

A printing system according to a present applied example is a printing system in which a printing device and an information terminal are connected via a communication. The printing system includes a first wired communication unit complying with a plug-and-play, which is configured to communicate with the information terminal by a wired connection, a confirmation unit configured to confirm that the first wired communication unit is communicably connected with the information terminal, and an application determination unit configured to determine an application to be booted at the information terminal and notify the information terminal of an application information with regards to the application being determined, by communicating with the first wired communication unit, when the confirmation unit confirms a connection. The information terminal includes a second wired communication unit complying with the plug-and-play, which is configured to communicate with the printing device in the wired communication, a wireless communication unit configured to communicate wirelessly with a node connected via a network, a determination unit configured to acquire the application information notified from the printing device by communicating the second wired communication unit and determine whether or not the application is installed, a node determination unit configured to determine the node at which the application is acquirable when the determination unit judges that the application is not installed, an install unit configured to acquire the application from the node by the wireless communication unit communicating with the node which is determined by the determination unit and install the application, and a boot unit configured to boot the application.

With the configuration, when the printing device and the information terminal are connected via the wired communication compatible to the plug-and-play, and the connection is confirmed, the printing device determines the application which is booted at the information terminal and notifies the information terminal, and when the application, and when the application which is notified is not installed, the information terminal acquires from the node which is acquirable via the wireless communication, installs, and boots the application. Thus, in addition to easily connect the printing device and the information terminal, the application which is determined by the printing device is booted for sure by notifying the information terminal of the application which is determined by the printing device, and the information terminal can boot the application for sure that is determined by the printing device, by acquiring from the node, as necessary, and installing.

For the printing system according to the above mentioned applied example, the application determination unit is further configured to generate the application information on the basis of a basic software which controls the information terminal.

With this configuration, the application information corresponding to the basic software controlling information devices is generated.

For the printing system according to the above mentioned applied example, the above mentioned application information includes at least one of string of text information for identifying the application, serial information for identifying a connection destination of the wired connection, and the address information for downloading the application from the node.

For the printing system of the above mentioned example, the printing device further includes a selection unit which is configured to select a process for data that is transmitted on the basis of the application booted at the information terminal.

With this configuration, the printing device quickly performs setting of the process at the printing device against the sent data by having the selection unit.

The printing device according to the above applied example is characterized in that the application information includes identification information by which the printing device is identifiable, and the information terminal includes a second boot unit that is configured to determine the application which is bootable on the basis of the identification information and boot the application.

With the configuration, it is easy to boot the application which is bootable on the basis of the printing device.

A control method for the printing system according to the present applied example, where the printing device and the information terminal are connected via a wired communication complying with the plug-and-play, includes confirming that the printing device and the information terminal are communicably connected, deciding an application to be booted at the information terminal by the printing device when a connection of the printing device and the information terminal is confirmed, notifying the information terminal by the printing device via the wired communication of an application information with regards to the application, acquiring by the information terminal the information which is notified from the printing device and determining whether or not the application is installed, deciding a node at which the application is acquirable by the information terminal when determining that the application is determined not installed, acquiring the application by the information terminal communicating wirelessly with the node via a network and installing the application being acquired, and booting the application by the information terminal.

By the method like this, the printing device and the information terminal are connected via the wireless communication and are compatible to the plug-and-play, the printing device notifies the information terminal of the application which is booted at the information terminal when the connection is confirmed, and the information terminal acquires via the wireless communication from the node being acquirable, installs, and boots the application when the application which is notified is not installed. Thus, in addition to easily connecting the print device and the information terminal, the application which printing device decides is booted for sure by notifying the information terminal of the application which the printing device decides, and by the information terminal acquiring from the node, as necessary, and installing.

### BRIEF DESCRIPTION OF THE DRAWINGS

Referring now to the attached drawings which form a part of this original disclosure:

FIG. 1 is a block diagram showing functional configuration of the printing system according to the present embodiment;

FIG. 2 is a flowchart showing flow of processes of the printing system according to the present embodiment;

FIG. 3 shows an example of a user interface screen displayed on the printing device;

FIGS. 4A, 4C, and 4C show an example of a user interface screen displayed on the information terminal; and

FIG. 5 shows an example of a user interface screen displayed on the information terminal.

### DETAILED DESCRIPTION OF EXEMPLARY EMBODIMENTS

Hereinbelow, embodiments of the present invention are described by referring to the figures.

### Embodiment

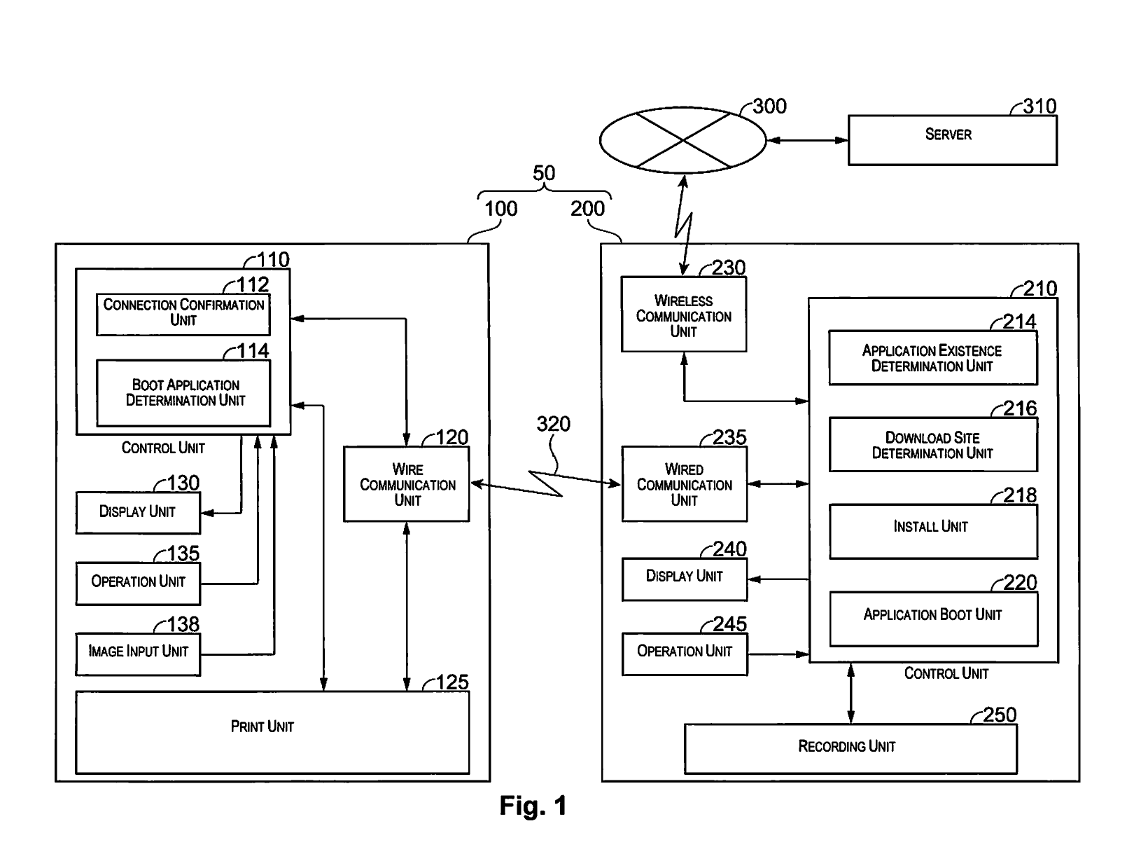

FIG. 1 is a block diagram showing functional configurations of a printing system 50 according to a present embodiment. For the printing system 50, a printing device 100 and an information terminal 200 are connected via a USB cable 320.

In the present embodiment, an ink-jet type printer which is assumed as the printing device 100, and a smartphone which is assumed as the information terminal 200 are not limited to them.

Also, the printing device 100 and the information terminal 200 are connected by a cable, and USB (Universal Serial Bus) is employed as the wired communication compatible to the plug-and-play which needs manual connection setting and identification, but not limited to this. For example, IEEE 1394 or the like can be employed.

The printing system 50 boots an application software (hereinafter application) which is installed on the information terminal 200, namely which is set to be bootable on the information terminal 200, transmits photographic images and physical address data which the application administrates to the printing device 100, and prints on a the print medium in a desired style.

### Printing Device

First, the printing device 100 which constitutes the printing system 50 is described. The printing device 100 includes a control unit 110, the wired communication unit 120, a print unit 125, a display unit 130, an operation unit 135, and an image input unit 138.

Also, the control unit 110 includes a connection confirmation unit 112 and a boot application determination unit 114.

By the way, the printing device 100 includes CPU, RAM, ROM and a memory device which are not shown in the figures as hardwares, and the control unit 110 realizes functions as these hardwares and a software which is recorded in the ROM or the memory device work together.

The connection confirmation unit 112 confirms that the printing device 100 is communicably connected to other devices via the USB cable 320. For example, when the wired communication unit 120 is connected to the information terminal 200 via the wired communication unit 235 and the USB cable 320, the wired communication unit 120 and the wired communication unit 235 do not need a setting process to each other by a user, and establish connection corresponding to a prescribed protocol on the basis of a USB standard, and it is possible to transmit date to each other.

The connection confirmation unit 112 confirms that the connection with the information terminal 200 is established, and notifies the boot application determination unit 114 of information indicating that the connection is established.

When the fact that the connection is established is notified from the connection confirmation unit 112 to the information terminal 200, the boot application determination unit 114 determines the application to request booting against the information terminal 200, generates application information to boot the application which is determined, and transmits the application information which is generated to the information terminal 200.

In the present embodiment, when the connection by the USB is established, the application requesting booting against the information terminal 200 administrates various data such as image data and personal data, and is assumed as the software to transmit the data between the information terminal 200 and the printing device 100. The application is recorded on the ROM or the like which is preset, and is assumed as one arrangement in which the user sets. Also, the basic software (OS) which controls a system of the information terminal 200 is assumed as iOS (registered trademark), Android (registered trademark), Windows Phone (registered trademark), or the like, and the application information is different on the basis of the OS. Thus, the boot application determination unit 114 acquires information of the OS of the information terminal 200, and generates the application information on the basis of the OS of the information terminal 200.

For example, when the OS of the information terminal 200 is Android, the application information includes string of text information to identify application including name of the application, a serial number (serial information) to identify a connection destination in a USB session setting, URL information (address information) to download the application via Internet, and a device name of the printing device 100. When the OS is not Android, the application information is substantially same as when the OS is Android, the application information is generated in a style to correspond to the OS.

The print unit 125 includes a print engine, a medium transferring device, or the like each of which is omitted in the figures. In the present embodiment, the image data of the a print target is assumed to be transmitted from the application of the information terminal 200 via the wired communication unit 120, but also assumed in a style in which the image input unit 138 displays in the print unit images read from a memory card, and the user designates the image of the print target by operating the operation unit 135.

When the print unit 125 starts a print process, print paper (not shown in the figures) configured on a prescribed position is led to a printing position by a medium transferring device, a carriage (now shown in the figures) which the print engine includes and is movable back-and-forth moves back-and-forth in a main scanning direction, and ink as a droplet is ejected on the basis of the image data against the print paper from a recording head (not shown in the figures) corresponding to a position to which the carriage is moved. Further, the print paper is intermittently led in a downstream direction in corresponding to moving back-and-forth in the main scanning direction, and an area of the print paper to which the ink is ejected is moved in series.

### Information Terminal

Next, the information terminal 200 which constitutes the printing system 50 is described. The information terminal 200 includes the control unit 210, a wireless communication unit 230, the wired communication unit 235, the display unit 240, the operation unit 245, and recording unit 250.

The wireless communication unit 230 can access to a desired node, for example a server 310, via a network 300 such as Internet by connecting to a public communication network via a wireless communication which uses radio wave used in cellphones. The wireless communication is not limited to a communication system which is used for the cellphones, such as 3G or 4G, and can be wireless LAN, Bluetooth, WiMax (registered trademark), or optical communication such as infrared light.

Also, the control unit 210 includes an application existence determination unit 214, a download site determination unit 216, an install unit 218, and an application boot unit 220.

The information terminal 200 includes CPU, RAM, ROM and the like each of which is not shown as hardware, and the control unit 210 realizes functions by these hardwares and a software which is recorded on ROM or the like working together.

The application existence determination unit 214 extracts the application name by analyzing the application information which is sent from the printing device 100, and determines whether or not the application corresponding to the application name being extracted has been installed in the information terminal 200.

When the application is determined being not installed at the application existence determination unit 214, the download site determination unit 216 determines an access destination to download the application. In the present embodiment, when access destination information (URL information) to download the application from the server 310 or the like, which is connected to the network 300, to download the application, the URL information being relevant is extracted from application information. The URL information is assumed being in an arrangement in which a website at which the application is acquirable is indicated. Also, the URL information is not included in the application information, and it is assumed being in an arrangement in which a portal site to download the application on the basis of an OS of the information terminal 200 is indicated. The download site determination unit 216 corresponds to the node determination unit.

The install unit 218 accesses the web site which the download site determination unit 216 determines, downloads the application from the server 310 which is prescribed to correspond to the website, and installs to boot at the information terminal 200. In this case, the install unit 218 renders the display unit 240 a screen which is requested by corresponding to the OS of the information terminal 200, and implements the installation on the basis of operation by the user on the operation unit 245.

The application boot unit 220 boots the application which corresponds to the application name of the application information, and provides the user of a service function which the booted application has. When the application has been installed in the information terminal 200 and when the wired communication unit 120 of the printing device 100 and the wired communication unit 235 of the information terminal 200 are connected via the USB cable 320, the application boot unit 220 is rendered to boot the application. Needless to say, it is fine to leave on the user of determining whether or not to boot.

The present embodiment assumes that the application is a photo print application or an address administrating application. The photo application displays on the display unit 240 a photograph recorded in the recording unit 250 or the like, and has a function of transferring image data of the photograph which is instructed by the user operating the operation unit 245 to the printing device 100.

Also, the address administrating application displays an address list which the user administrates on the display unit 240, and has a function of transferring data of the address list instructed by the user operating the operation unit 245 to the printing device 100.

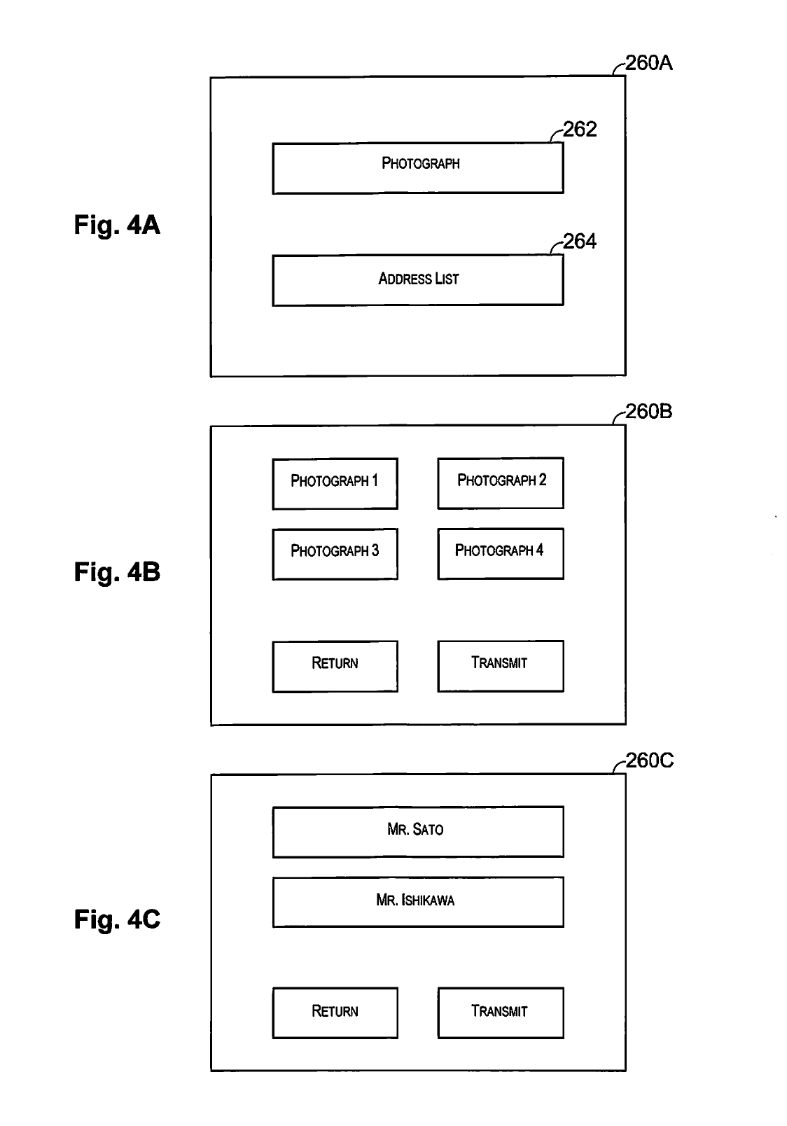

Here, the photo print application the address administrating application are described by referring to FIGS. 4A, 4B, and 4C. The application boot unit 220 renders the display unit 240 display a user interface screen 260A which is shown in FIG. 4A as the display unit 240 displays, and the user can select an application to boot. For example, when the user pushes a photo button 262, the photo print application is started, and the user interface screen 260B of the photo print application which is shown in FIG. 4B is displayed on the display unit 240.

Also, when the user pushes an address button 264, the address administrating application is stated, and the user interface screen 260C of the address administrating application, as shown in FIG. 4C, is displayed on the display unit 240. The button for each individual person which is displayed on the user interface screen 260C is related to individual attribute data such as a corresponding individual name, address, telephone number, date of birth, and the like.

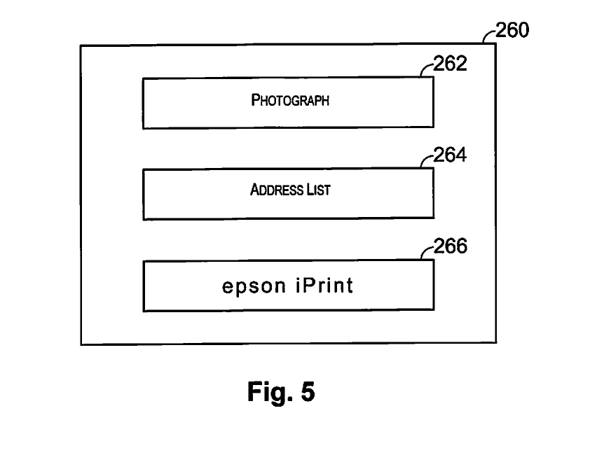

Also, the application boot unit 220 displays the user interface screen 260 which is shown in FIG. 5 as the display unit 240 displays, and the user can select the application to boot. Here, a launcher button 266 of a support application (in this case Epson iPrint) which supports to correspond to a device name (identification information) of the printing device 100 which is received by the information terminal 200 when the printing device 100 and the information terminal 200 are connected is displayed on the user interface screen 260. The launcher button 266 is equivalent to the second boot unit.

When the application corresponding to the information terminal 200 is not installed, and the user pushes the launcher button 266, it proceeds to the download site and is possible to download the desired application.

Resource data (for example, image data, the URL information to download, corresponding device name) of the launcher button 266 to be displayed are assumed to be an arrangement in which the information terminal 200 has beforehand.

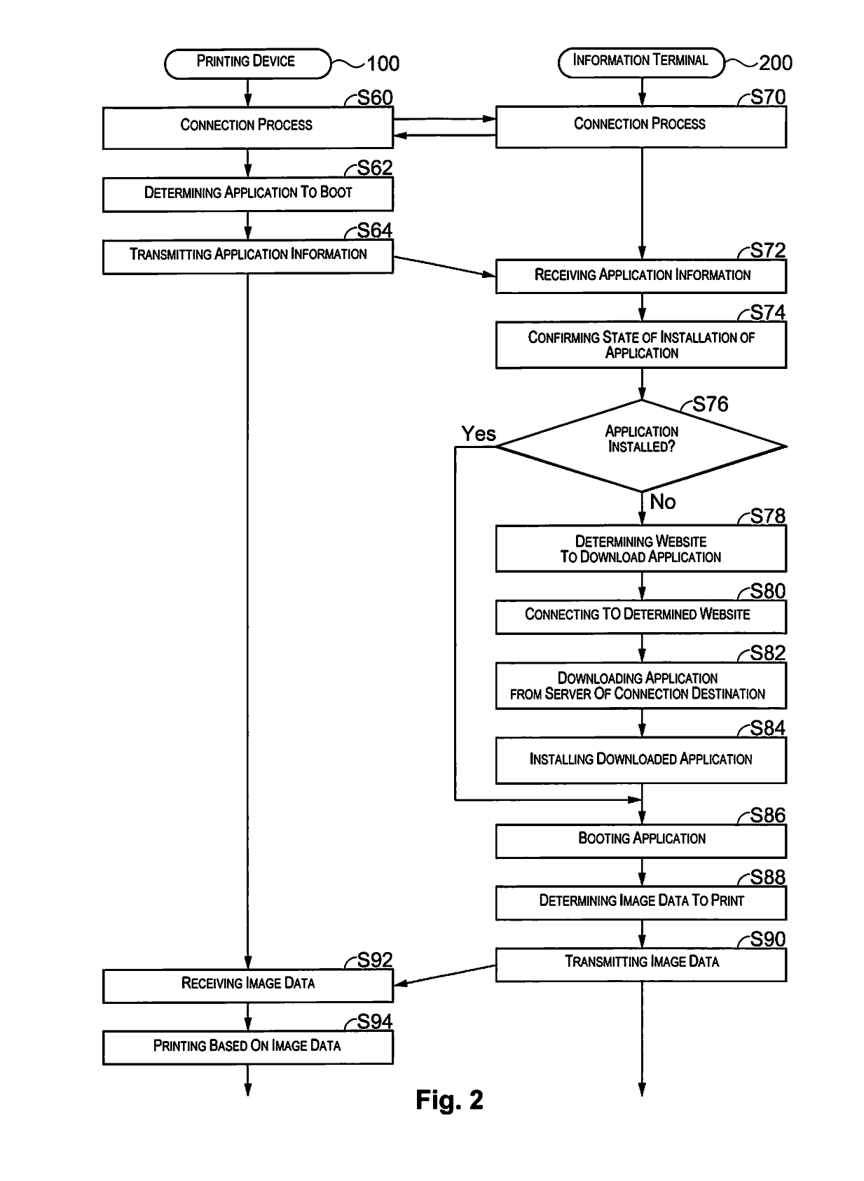

FIG. 2 is a flowchart showing a part of a flow of a control method of the printing system 50. First, when the printing device 100 and the information terminal 200 are connected in wired connection via the USB cable 320, the printing device 100 and the information terminal 200 perform a connection process to be connected (step S60, step S70).

Next, the printing device 100 confirms establishment of the connection with the information terminal 200 <a confirmation step>, and decides the application to boot at the information terminal 200 (step S62) <a decision step>.

Next, the printing device 100 generates the application information on the basis of the decided application, and transmits the generated application information to the information terminal 200 (step S64) <a notification step>. The information terminal 200 receives the application information which is transmitted from the printing device 100 (step S72), and confirms an installation state of the application on the basis of the received application information (step S74) <a determination step>.

Here, when the information terminal 200 determines that the application has been installed (YES at step S76), it proceeds to step S86.

On the other hand, when the information terminal 200 determines that the application has not been installed (No at step S76), the website from which the application is downloaded is decided (step S78) <node decision step>.

Next, the information terminal 200 is connected to the website wirelessly (step S80), and downloads the application from the server 310 of the connection destination (step S82).

Next, the information terminal 200 installs the downloaded application (step S84) <an installation step>, and it proceeds to step S86.

At step S86, the information terminal 200 boots the application <a booting step>, and determines image data to be printed on the basis of an operation of the user against the booted application (step S88).

Next, the information terminal 200 transmits the image data which is decided to the printing device 100 (step S90).

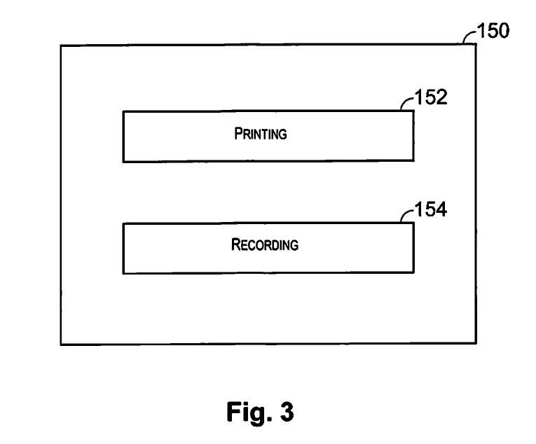

The printing device 100 receives the image data transmitted from the information terminal 200 (step S92), and prints the image on the basis of the received image data (step S94). It can be assumed that the received image data is not printed immediately and saved in the printing device 100. For example, when a user interface screen 150 as shown in FIG. 3 is displayed on the display unit 130, and when the user pushes the button 152 to print, the image is printed. On the other hand, when the user pushes a button 154 to save, the image is saved in a recording unit (not shown in the figures) of the printing device 100 without being printed.

According to the embodiments described above, there are effects below.

(1) Because the information terminal 200 and the printing device 100 are connected to each other on the basis of the USB standard which corresponds to the plug-and-play, the data communication between them connecting by the USB cable 320, and the user, after connecting, transmits the image to print to the printing device 100 by operating the information terminal 200 without the connection setting, and can print the desired image which is from the printing device 100. Thus, it is possible to quickly print the desired image on the information terminal 200.

(2) Because the information terminal 200 and the printing device 100 are connected in wired connection, it is possible to prevent data between them from leaking to outside, and retain the data secret.

(3) In a case in which the connection between the information terminal 200 and the printing device 100 is ended, there is no need for any connection ending process, and it is possible to end easily the established printing system 50.

Each of the configurations and any combination thereof in the embodiments are examples, and it is possible to add, omit, exchange, and change the configurations is possible as long as it is within the idea of the present invention. Also, the present invention is not limited to the embodiments, but only by the scope of the claims.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A printing system in which a printing device and an information terminal are connected via a communication, the printing system comprising:
the printing device including
a first wired communication unit complying with a plug-and-play, the first wired communication unit being configured to communicate with the information terminal by a wired connection,
a confirmation unit configured to confirm that the first wired communication unit is communicably connected to the information terminal, and
an application determination unit configured to determine an application to be booted at the information terminal, and notify the information terminal by communicating by the first wired communication unit of an application information with regards to the application, when the confirmation unit confirms a connection;
the information terminal including
a second wired communication unit complying with the plug-and-play, the second wired communication unit being configured to communicate with the printing device in the wired connection,
a wireless communication unit configured to communicate wirelessly with a node which is connected via a network,
a determination unit configured to acquire the application information which is notified from the printing device by communicating with the second wired communication unit, and determine whether or not the application is installed,
a node determination unit configured to determine the node at which the application is acquirable, when the determination unit judges that the application is not installed, and
an install unit configured to acquire the application from the node by the wireless communication unit communicating with the node which is determined by the determination unit and install the application being acquired.

2. The printing system according to claim 1, wherein
the application determination unit is further configured to generate the application information corresponding to a basic software which controls the information terminal.

3. The printing system according to claim 3, wherein
the application information includes at least one of string of text information to identify the application, serial information to identify a connection destination on the wired connection, and address information to download the application from the node.

4. The printing system according to claim 2, further comprising
a boot unit configured to boot the application.

5. The printing system according to claim 4, wherein
the printing device further includes a selection unit configured to select a process for data which is transmitted based on the application booted at the information terminal.

6. The printing system according to claim 5, wherein
the application information includes identification information by which the printing device is identifiable, and
the information terminal includes a second boot unit configured to determine the application which is bootable based on the identification information, and boot the application being determined.

7. A control method for a printing system in which a printing device and an information terminal are connected in a wired communication which complies with a plug-and-play, the control method comprising:
confirming that the printing device and the information terminal are communicably connected;
deciding an application which the printing device boots at the information terminal, when a connection of the printing device and the information terminal is confirmed;
notifying the information terminal by the printing device of an application information with regards to the application via the wired communication;
acquiring by the information terminal the information which is notified from the printing device and determining whether or not the application is installed;
deciding a node at which the application is acquirable by the information terminal when determining that the application is not installed; and
acquiring the application by the information terminal communicating wirelessly with the node via a network, and installing the application being acquired.
